(19) United States
(12) Patent Application Publication
(10) Pub. No.: US 2007/0070595 A1
(43) Pub. Date: Mar. 29, 2007

(54) Screwless device for attaching and detaching disk drive

(75) Inventors: Yu-Ling Chen, Taoyuan Hsien (TW); Yin-Kang Tu, Taoyuan Hsien (TW)

Correspondence Address: TROXELL LAW OFFICE PLLC, Suite 1404, 5205 Leesburg Pike, Falls Church, VA, 22041, US

(73) Assignee: Enlight Corporation

(21) Appl. No.: 11/236,586

(22) Filed: Sep. 28, 2005

(51) Int. Cl. G06F 1/16

(52) U.S. Cl. 361/685

(57) ABSTRACT

A screwless device for attaching and detaching a disk drive comprises a base and a frame body. The base comprises at least a rotation bracket, an elastic location plate, a fixing plate, and protrudent joints. Two first axle holes are located on both sides of the rotation bracket respectively for being inserted by an axle to which a torsion spring is sleeved. A buckle hole is formed on the elastic location plate. The frame body is designed for being attached to the base. The frame body comprises: a mounting chamber for holding the disk drive; an axle-connecting part; and a buckle means mounted on the same side of the frame body as the elastic location plate. Second axle holes and buckle notches are formed on the axle-connecting part. Several open trenches are formed in opposition to the protrudent joints.

### FIELD OF THE INVENTION

The present invention relates to a screwless device, and more particularly to a screwless device for attaching and detaching a disk drive, for example, a hard disk drive, a soft disk drive, a CD-ROM drive, a card reader, etc.

### BACKGROUND OF THE INVENTION

The general hard disk drive, soft disk drive, CD-ROM drive, and card reader are usually fixedly mounted by a simple mechanical structure. In the conventional structure, the hard disk drive is fixedly secured to a frame body by several fixing devices after the hard disk drive has been located on the frame body. As a result, it requires unavoidably much time and work for applying a tool to attachment and detachment of the fixing devices.

### SUMMARY OF THE INVENTION

In view of the above-mentioned problems, the present invention discloses a screwless device for attaching and detaching a disk drive, for example, a hard disk drive, a soft disk drive, a CD-ROM drive, a card reader, etc. When providing the frame body with a specific lifting angle, a plurality of holes formed on the bottom of the disk drive are located in opposition to the open trenches such that the protrudent joints protruding from the base can be inserted into the holes of the disk drive for locating the disk drive. In addition, the buckle means mounted on one side of the frame body can be buckled to the buckle hole of the elastic location plate so as to fixedly secure the frame body to the base. In addition, if there is a need to detach the hard disk drive, the elastic location plate is pushed outward so as to separate the buckle means from the buckle hole. Thereafter, the frame body can be lifted up for taking out the hard disk drive easily.

### BRIEF DESCRIPTION OF THE DRAWINGS

FIG. 1 is an elevational view showing the structure of the present invention.

FIG. 2 is an elevational view showing the pivotal rotation of the frame body of the present invention.

FIG. 3 is an exploded, elevational view showing the structure of the present invention.

FIG. 4 is an elevational view showing the assembly of the base, the frame body, and the hard disk drive in accordance with the present invention.

FIG. 5 is an elevational view showing that the hard disk drive is attached to the structure of the present invention.

FIG. 6 is an exploded, elevational view showing the assembly process for attaching the hard disk drive to the structure of the present invention.

### DETAILED DESCRIPTION OF THE PREFERRED EMBODIMENT

The above-mentioned features and advantages of this invention, and the manner of attaining them, will become more apparent and the invention will be better understood by reference to the following description of embodiments of the invention taken in conjunction with the drawings.

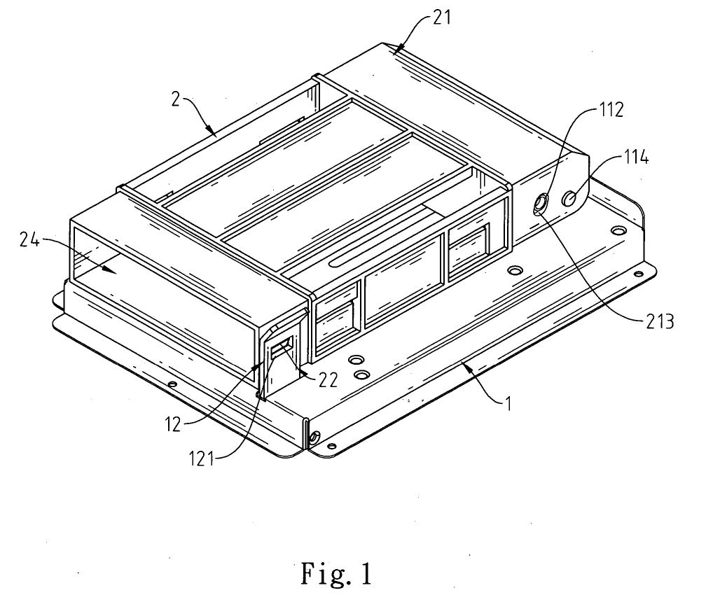

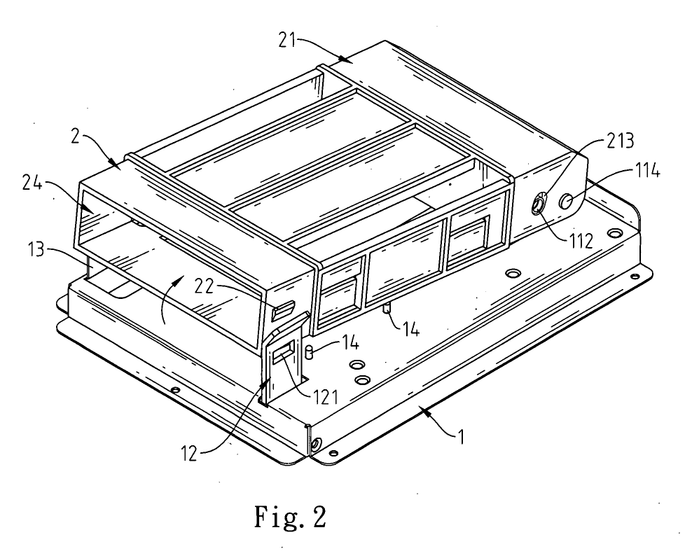

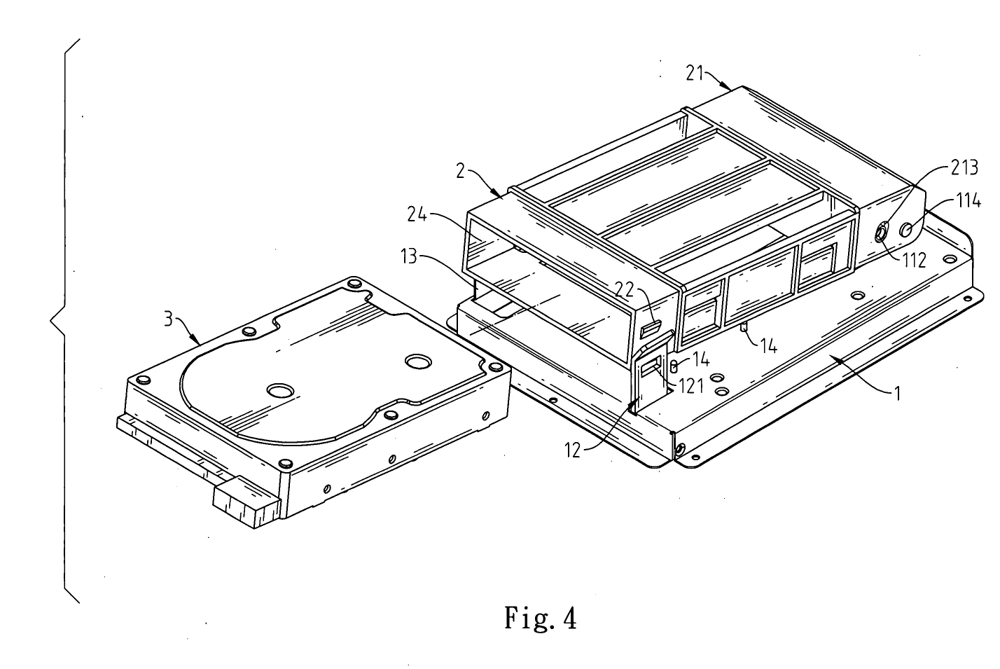

Referring to FIG. 1 through FIG. 4, a screwless device for attaching and detaching a disk drive of the present invention comprises a base 1 and a frame body 2, wherein the frame body 2 is pivotally connected to the top of the base 1 for holding a disk drive, for example, a hard disk drive, a soft disk drive, a CD-ROM drive, a card reader, etc. Moreover, the attaching and detaching processes of these apparatuses can be performed easily by use of the frame body 2 since there is no more need to utilize the conventional fixing devices such as screws.

The above-mentioned base 1 comprises at least a rotation bracket 11, an elastic location plate 12, a fixing plate 13, and a plurality of protrudent joints 14, wherein the frame body 2 is mounted above the base 1 and the rotation bracket 11 is mounted on the back of the base 1. The rotation bracket 11 has two axle holes 111 located on both sides, respectively, for being inserted through by an axle 114 to which a torsion spring 113 is sleeved such that the torsion spring 113 is axially mounted between the axle holes 111. The paired elastic location plate 12 and fixing plate 13 are mounted on the front of the base 1. The elastic location plate 12 further has a buckle hole 121 formed thereon. The protrudent joints 14 are mounted on the top of the base 1 to which the frame body 2 is assembled.

The frame body 2 has a mounting chamber 24 for holding a hard disk drive 3. Instead of holding the hard disk drive 3, the mounting chamber 24 is also designed for holding a soft disk drive, a CD-ROM drive, or a card reader. The frame body 2 has an axle-connecting part 21 mounted on the back thereof. The axle-connecting part 21 has axle holes 211 and buckle notches 212 formed thereon. A plurality of open trenches 23 are formed on the bottom of the frame body 2 in opposition to the protrudent joints 14 on the base 1. Besides, a buckle means 22 is mounted on the same side of the frame body 2 as the elastic location plate 12.

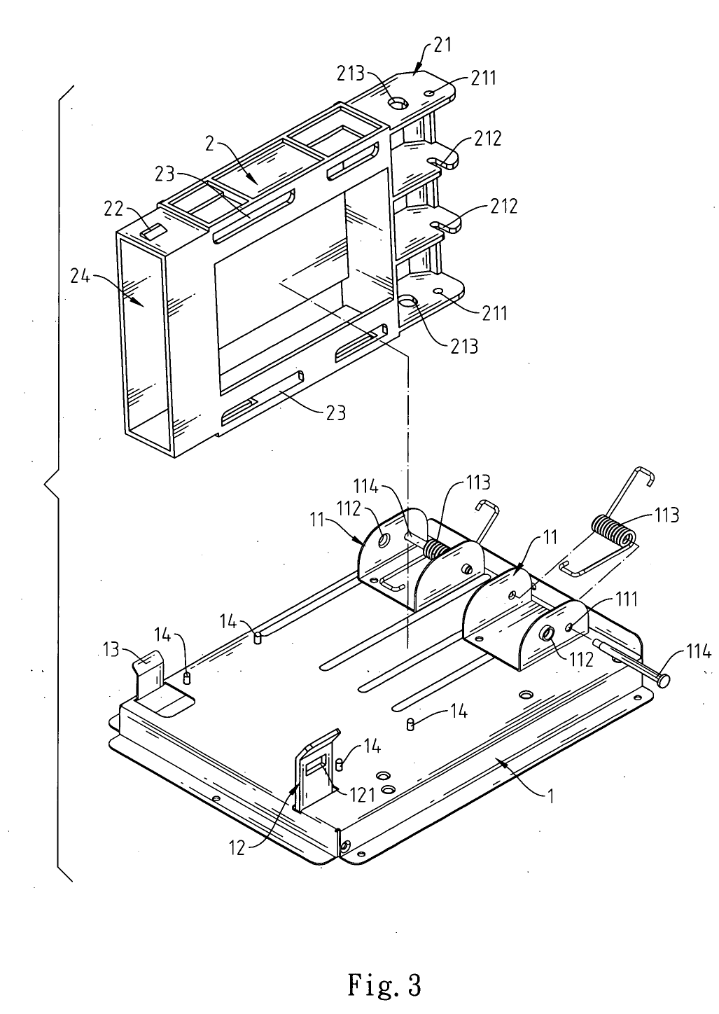

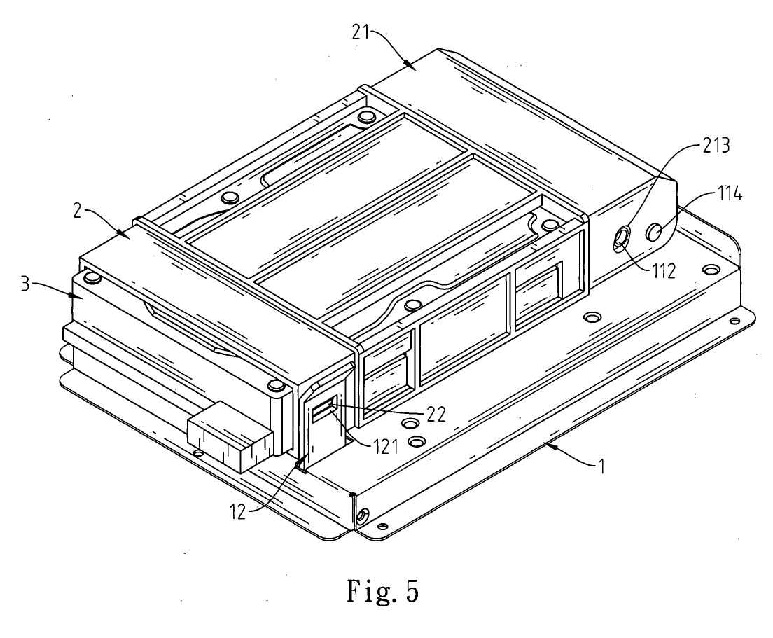

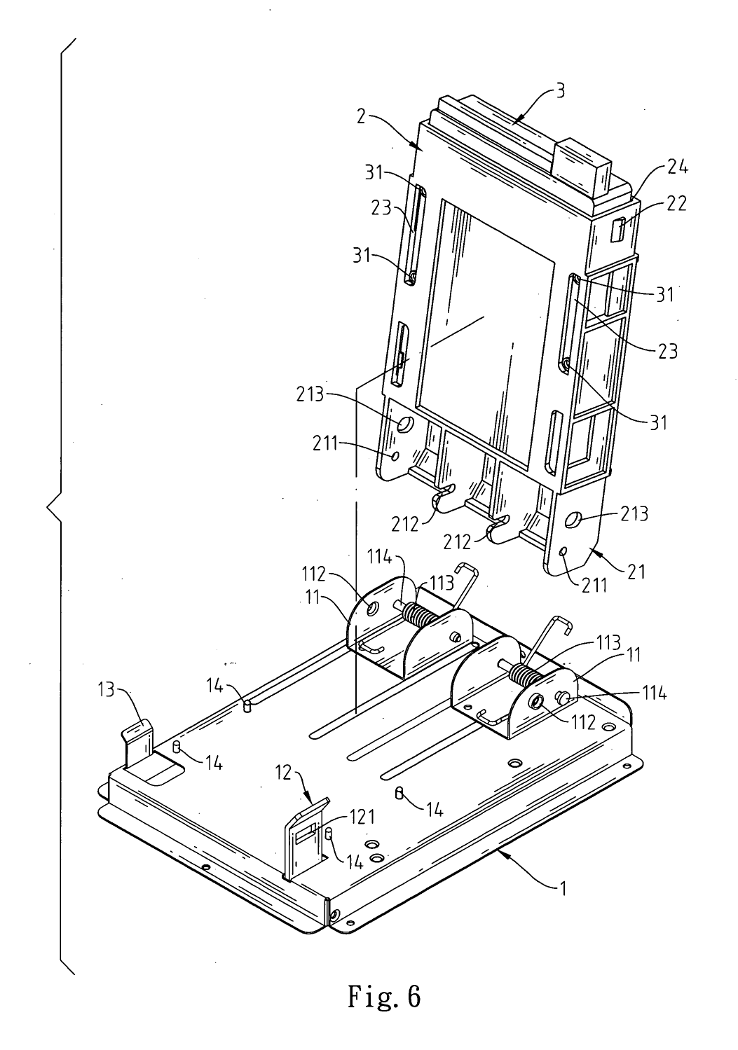

Referring further to FIG. 3 through FIG. 6, when transversely inserting the axle 114 into the frame body 2 for attaching the frame body 2 to the base 1, the frame body 2 is pivotally rotatable on the rotation bracket 11 of the base 1. The rotation bracket 11 further has two protrudent joints 112 on its both sides, respectively. If the frame body 2 is attached to the base 1, the protrudent joints 112 can be exactly inserted into elongated holes 213 of the axle-connecting part 21, respectively. Therefore, the protrudent joints 112 are movable within the elongated holes 213 when pivotally rotating the frame body 2. In other words, the lifting angle of the frame body 2 is confined to a specific value. Accordingly, in normal condition, the frame body 2 is restrained by the elongated holes 213 to keep it from excessive rotation.

Referring continuously to FIG. 3 through FIG. 5, when providing the frame body 2 with the specific lifting angle for insertion of the hard disk drive 3 into the mounting chamber 24, a plurality of holes 31 formed on the bottom of the hard disk drive 3 are located in opposition to the open trenches 23. As a result, if the frame body 2 is pivotally downward rotated, the protrudent joints 14 protruding from the base 1 are inserted into the holes 31 of the hard disk drive 3 for locating the hard disk drive 3. In addition, the buckle means 22 mounted on one side of the frame body 2 can be buckled to the buckle hole 121 of the elastic location plate 12 so as to fixedly secure the frame body 2 to the base 1. In addition, if there is a need to detach the hard disk drive 3, the elastic location plate 12 is pushed outward so as to separate the buckle means 22 from the buckle hole 121. Thereafter, the frame body 2 can be lifted up for taking out the hard disk drive easily.

What the invention claimed is:

1. A screwless device for attaching and detaching a disk drive comprising:
a base comprising at least a rotation bracket mounted on the back of the base, an elastic location plate mounted on the front of the base, a fixing plate mounted on the front of the base, and a plurality of protrudent joints mounted on a top surface of the base, wherein two first axle holes are formed on both sides of the rotation bracket respectively for being inserted by an axle to which a torsion spring is sleeved and a buckle hole is formed on the elastic location plate; and
a frame body for being attached to the top surface of the base, the frame body comprising: a mounting chamber for holding the disk drive; an axle-connecting part mounted on the back of the frame body; and a buckle means mounted on the same side of the frame body as the elastic location plate, wherein two second axle holes and two buckle notches are formed on the axle-connecting part, and a plurality of open trenches are formed on the bottom of the frame body in opposition to the protrudent joints.
